(19) United States
(12) Patent Application Publication
(10) Pub. No.: US 2012/0102839 A1
(43) Pub. Date: May 3, 2012

(54) All-Glass Door Assembly

(75) Inventors: Oliver Walhorn, Werther (DE); Jörg Sunderbrink, Bad Oeynhausen (DE); Ralf Kreyenborg, Bad Salzuflen (DE)

(73) Assignee: Dorma GmbH + Co. KG, Ennepetal (DE)

(21) Appl. No.: 13/260,703

(22) PCT Filed: Mar. 17, 2010
(86) PCT No.: PCT/EP10/01657

§ 371 Date: Dec. 23, 2011

(30) Foreign Application Priority Data
Mar. 31, 2009 (DE) 10 2009 015 181.8

(51) Int. Cl. E06B 3/02; E06B 3/36

(52) U.S. Cl. 49/399

(57) ABSTRACT

An all-glass door assembly having an all-glass door supported by an upper and a lower pivotal fitting, which form a vertical axis of rotation, and having at least one lateral panel. A vertical edge of the lateral panel is disposed in an area between the pivotal fittings and adjoining the axis of rotation.

### CROSS REFERENCE TO RELATED APPLICATION

This is a U.S. national stage of application No. PCT/EP2010/001657, filed on 17 Mar. 2010. Priority is claimed on German Application No. 10 2009 015 181.8, filed 31 Mar. 2009, the content of which are incorporated here by reference.

### BACKGROUND OF THE INVENTION

1. Field of the Invention

The invention relates to an all-glass door assembly having an all-glass door supported by an upper and a lower pivotal fitting and a lateral panel adjoining the all-glass door in the area of the axis of rotation.

2. Description of Related Art

It is known from the state-of-the-art to utilize a pivotal fitting with all-glass doors, in which the door leaf of the all-glass door rotates about a vertical axis. On account of the construction of the pivotal fitting, in particular in the floor area and in particular also when utilizing a floor door closer, the axis of rotation of the door leaf can not be disposed exactly at the vertical edge of the door leaf. This means that the axis of rotation is offset in the direction of the center of the door leaf. Thus, when pivoting the door, a secondary closing edge is created. When opening the door, a free space is thus created between the door and the lateral panels, with the risk, especially for playing children, to reach with their hands into this free space and to grasp the lateral panel or the door leaf. When closing the door, a considerable risk of injury is given by pinching the hands or fingers.

### SUMMARY OF THE INVENTION

An object of one embodiment of the invention is to create an all-glass door assembly of the type mentioned in the introduction, which is safe to operate and excludes the risk of injury.

According to one embodiment of the invention, the vertical edge of the lateral panel be disposed in an area between the pivotal fittings and adjoining the axis of rotation.

According to one embodiment of the invention, the lateral panel protrudes in an area between the two pivotal fittings. The lateral panel therefore has a protruding area, which, compared to the solutions of the state-of-the-art, would have been covered by the door leaf of the all-glass door. As the edge of the lateral panel is now located adjacent to or on the axis of rotation, when opening the all-glass door, no gap is created into which one could possibly reach. Therefore, there is no secondary closing edge, such that, except for the pivotal fittings, the entire structure is jam-free. As the pivotal fittings are located only in the uppermost and the lowermost areas of the door and respectively have only a very low vertical height, it can be excluded that individuals reach into these areas, because, as for the upper pivotal fitting, they can not reach that high up, and as for the lower pivotal fitting, they would have first to lie down or kneel on the floor. Therefore, the entire all-glass door assembly is configured to be jam-free and safe.

The inventive solution is simple and can be realized in a cost-effective manner. In this case, depending on the structure, it is simply required to shorten the door glass over the entire length by a predefined measure on the side of the fitting and/or to widen the lateral glass panel by a defined value between the upper and lower pivotal fittings.

According to one embodiment of the invention, the secondary closing edge is thus located on the axis of rotation or, depending on the thickness of the door leaf of the all-glass door, directly adjoining the axis of rotation.

The invention will now be described in more detail, reference being made to one embodiment.

### BRIEF DESCRIPTION OF THE DRAWINGS

The Figures show:

FIG. 1 is a diagrammatical lateral view of an all-glass door assembly;

FIG. 2 is a view analogously to FIG. 1 without pivotal fittings; and

FIG. 3 is a top view on the assembly according to FIGS. 1 and 2, in a partially opened condition of the all-glass door.

### DETAILED DESCRIPTION OF THE PREFERRED EMBODIMENTS

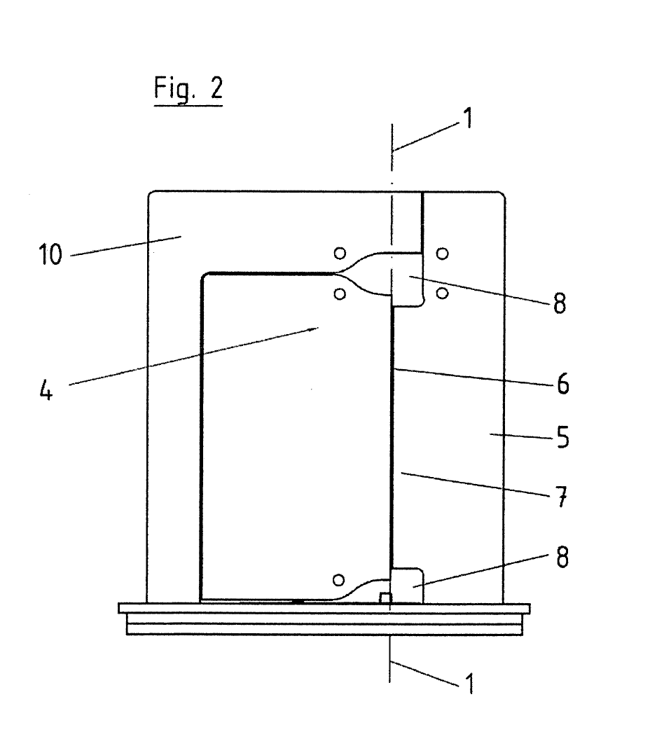

In the illustrated embodiment of the inventive all-glass door assembly, an all-glass door 4 is provided, which is supported by an upper pivotal fitting 2 and a lower pivotal fitting 3. A floor door closer, to which the lower pivotal fitting 3 is operatively connected, is diagrammatically illustrated by the reference numeral 9. The upper pivotal fitting 2 is connected to a lateral panel 5 and an overpanel 10, shown in FIG. 2.

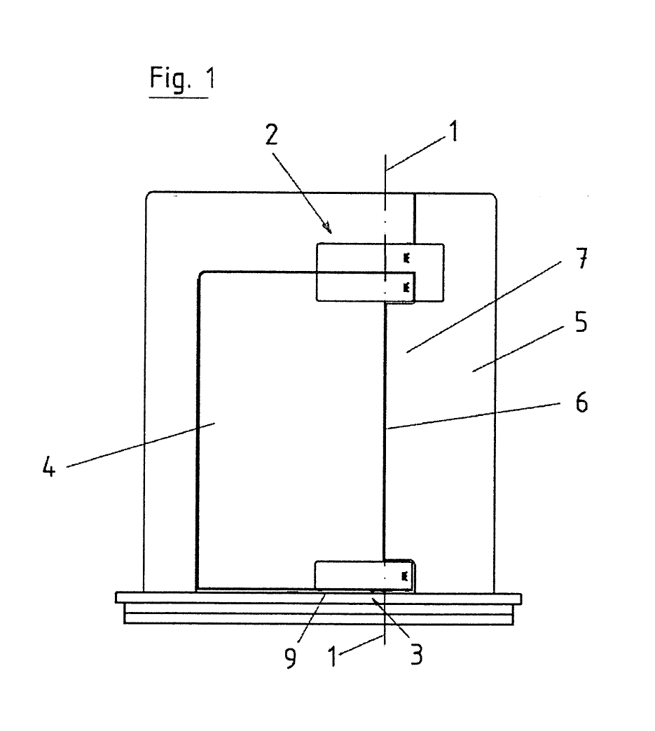

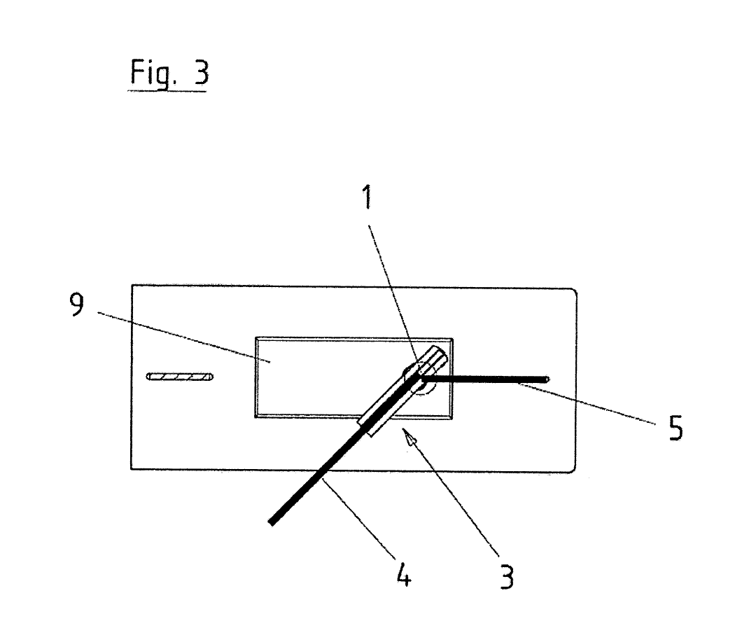

As can be seen in particular in FIG. 2, at its vertical edge 6 oriented towards the all-glass door 4, the lateral panel 5 has a projecting or protruding area 7, which (refer to FIG. 1) extends between the two pivotal fittings 2, 3. Therefore, the vertical axis of rotation 1 is located on or directly adjacent to the vertical edge 6, such as to result in the configuration shown in FIG. 3, in which the secondary closing edge of the door leaf of the all-glass door 4 is jam-free.

In particular FIG. 2 shows furthermore that the lateral panel 5 has an upper and a lower recess 8, in order to be able to accommodate the respective parts of the pivotal fittings 2, 3.

It should be understood that in particular the configuration of the lateral panel 5, as well as of the pivotal fittings 2, 3 can be adapted to the respective installation conditions. The inventive solution may be provided with or without overpanel.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-4. (canceled)

5. A door assembly comprising:
a door;
an upper pivotal fitting configured to support the door;
a lower pivotal fitting configured to support the door;
a vertical axis of rotation formed by the upper and lower pivotal fittings;
at least one lateral panel, having a vertical edge disposed in an area between the upper and lower pivotal fittings and adjoining the axis of rotation.

6. The door assembly according to claim 5, wherein, between the upper and lower pivotal fittings, the lateral panel is provided with an area extending towards the door.

7. The door assembly according to claim 5, wherein the upper and lower pivotal fittings are arranged to protrude beyond the vertical edge of the door.

8. The door assembly according to claim 5, wherein, in the area of the upper and lower pivotal fittings, the lateral panel is provided with a recess.

9. The door assembly according to claim 6, wherein the upper and lower pivotal fittings are arranged to protrude beyond the vertical edge of the door.

10. The door assembly according to claim 7, wherein, in the area of the upper and lower pivotal fittings, the lateral panel is provided with a recess.

11. The door assembly according to claim 5, wherein the door assembly is an all-glass door assembly.
